(19) United States
(12) Patent Application Publication
(10) Pub. No.: US 2004/0131899 A1
(43) Pub. Date: Jul. 8, 2004

(54) System and method for process gas stream delivery and regulation using down spool control

(75) Inventors: Joseph Cargnelli, Toronto (CA); Todd A. Simpson, Brampton (CA); Stephen Burany, Thornhill (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/667,888

(22) Filed: Sep. 23, 2003

Related U.S. Application Data
(60) Provisional application No. 60/412,547, filed on Sep. 23, 2002.
(60) Provisional application No. 60/412,588, filed on Sep. 23, 2002.

(51) Int. Cl. H01M 8/04

(52) U.S. Cl. 429/13; 429/22; 429/23

(57) ABSTRACT

A method and apparatus are provided for delivery and regulation of a process fluid to a multi-cell electrochemical device. A controller regulates the process fluid flow, after at least one of the process parameters indicates a drop in load current draw, based on the operating rate of the fuel cell and the rate of decrease in the load.

### FIELD OF THE INVENTION

The present invention relates to a system and method for delivering and regulating process gas streams to fuel cell stacks.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduced to the second electrode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the two electrodes are, respectively, as follows:

H2→2H++2e−½O₂+2H++2e−→H₂O

The external electrical circuit withdraws electrical current and thus receives electrical power from the cell. The overall fuel cell reaction produces electrical energy as shown by the sum of the separate half-cell reactions written above. Water and heat are typical by-products of the reaction.

In practice, fuel cells are not operated as single units. Rather, fuel cells are connected in series, stacked one on top of the other, or placed side by side. A series of fuel cells, referred to as fuel cell stack, is normally enclosed in a housing. The fuel and oxidant are directed through manifolds to the electrodes, while cooling is provided either by the reactants or by a cooling medium. Also within the stack are current collectors, cell-to-cell seals and insulation, with required piping and instrumentation provided externally of the fuel cell stack. The stack, housing, and associated hardware make up the fuel cell module.

The optimal operating level of components of the fuel cell system will depend upon the particular system operating level of the entire fuel cell system. Thus, for example, the optimal operating level of a blower for providing a process fluid to the fuel cell system will depend upon the particular system operating level of the fuel cell system. As the operating level of the fuel cell system increases, the optimal operating level of the blower will also increase. Analogously, as the operating level of the fuel cell decreases, the optimal operating level of the blower will decrease. In prior art systems, feedback from process parameters, such as cathode airflow, various temperatures and fuel cell voltages, are monitored and are used to either increase or decrease the operating level of individual components of the fuel cell system based upon the needs of the fuel cell system.

### SUMMARY OF THE INVENTION

In accordance with an aspect of the present invention, there is provided a method of operating a fuel cell system. The method comprises (a) operating a component of the fuel cell system at a component operating rate; (b) driving a load using the fuel cell; (c) measuring an operating rate of the fuel cell; (d) normally adjusting the component operating rate in dependence upon the operating rate of the fuel cell; and, (e) in response to selected changes in the operating rate of the fuel cell, indicative of corresponding changes in the demand from the load, delaying adjustment of the component operating rate.

In accordance with a second aspect of the present invention, there is provided a fuel cell system comprising (a) a fuel cell for driving a load; (b) at least one measuring device for monitoring an operating rate of the fuel cell; (c) a controller for controlling an operation rate of a component of the fuel cell system based on the operating rate of the fuel cell; and, (d) means for detecting selected changes in the operating rate of the fuel cell, indicative of corresponding changes in the demand from the load, and in response thereto, delaying adjustment of the operation rate of the component.

### BRIEF DESCRIPTION OF THE DRAWINGS

For a better understanding of the present invention and to show more clearly how it may be carried into effect, reference will now be made, by way of example, to the accompanying drawings which show an embodiment of the present invention and in which;

FIG. 1 is a schematic flow diagram of a first embodiment of a fuel cell gas and water management system in accordance with an aspect of the present invention; and,

FIG. 2 is a block diagram of a controller for use in connection with the fuel cell gas and water management system of FIG. 1 in accordance with an embodiment of the invention.

### DETAILED DESCRIPTION OF THE INVENTION

For delivering and regulating process fluids, for example air and hydrogen gas streams, to a fuel cell stack, it is important to provide the process fluids in a required amount at a precise time. The following description will use as an example the delivery and regulation of air to a cathode portion of a fuel cell stack 12. The same general principles can also be applied to other fluid deliveries, for example the hydrogen gas stream to the fuel cell stack.

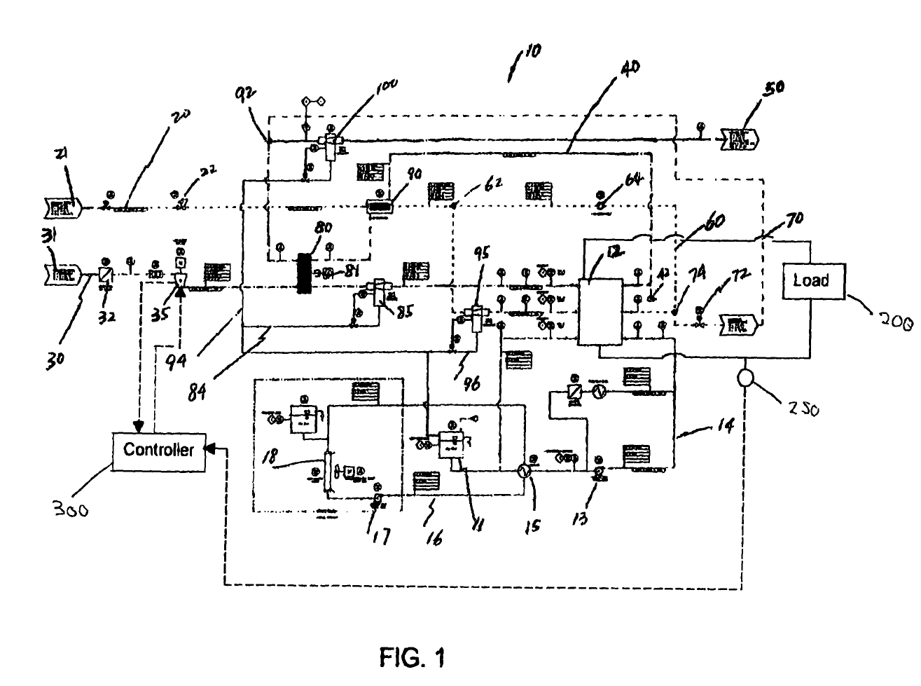

Referring to FIG. 1, this shows a schematic flow diagram of a fuel cell gas management system 10 in accordance with an aspect of the present invention. The fuel cell gas management system comprises a fuel supply line 20, an oxidant supply line 30, a cathode exhaust recirculation line 40 and an anode exhaust recirculation line 60, all connected to the fuel cell 12. It is to be understood that the fuel cell may comprise a plurality of fuel cells (a fuel cell stack) or just a single fuel cell. For simplicity, the fuel cell 12 described herein operates on hydrogen as fuel and air as oxidant and can be a Proton Exchange Membrane (PEM) fuel cell. However, the present invention is not limited to this type of fuel cells and is applicable to other types of fuel cells that rely on other fuels and oxidants.

The fuel supply line 20 is connected to a fuel source 21 for supplying hydrogen to the anode of the fuel cell 12. A hydrogen humidifier 90 is disposed in the fuel supply line 20 upstream from the fuel cell 12 and an anode water separator 95 is disposed between the hydrogen humidifier 90 and the fuel cell 12. The oxidant supply line 30 is connected to an oxidant source 31, e.g. ambient air, for supplying air to the cathode of the fuel cell 12. An enthalpy wheel 80 is disposed in the oxidant supply line 30 upstream of the fuel cell 12 and also in the cathode recirculation line 40. A cathode water separator 85 is disposed between the enthalpy wheel 80 and the fuel cell 12. The enthalpy wheel 80 comprises porous material with a desiccant. In known manner, a motor 81 drives either the porous materials or a gas diverting element to rotate around the axis of the enthalpy wheel so that gases from the oxidant supply line 30 and the oxidant recirculation line 40 alternately pass through the porous materials of the enthalpy wheel. Dry ambient air enters the oxidant supply line 30 and first passes through an air filter 32 that filters out the impurity particles. A blower 35 is disposed upstream of the enthalpy wheel 80, to draw air from the air filter 32 and to pass the air through a first region of the enthalpy wheel 80. The enthalpy wheel 80 may be any commercially available enthalpy wheel suitable for fuel cell system, such as the one described in the applicant's co-pending U.S. patent application Ser. No. 09/941,934.

A fuel cell cathode exhaust stream contains excess air, product water and water transported from the anode side, the air being nitrogen rich due to consumption of at least part of the oxygen in the fuel cell 12. The cathode exhaust stream is recirculated through the cathode exhaust recirculation line 40 connected to the cathode outlet of the fuel cell 12. The humid cathode exhaust stream first passes through the hydrogen humidifier 90 in which the heat and humidity is transferred to incoming dry hydrogen in the fuel supply line 20. The humidifier 90 can be any suitable humidifier, such as that commercially available from Perma Pure Inc, Toms River, N.J. It may also be a membrane humidifier and other types of humidifier with either high or low saturation efficiency. In view of the gases in the anode and cathode streams, an enthalpy wheel or other device permitting significant heat and humidity interchange between the two streams cannot be used.

From the hydrogen humidifier 90, the fuel cell cathode exhaust stream continues to flow along the recirculation line 40 and passes through a second region of the enthalpy wheel 80, as mentioned above. As the humid cathode exhaust passes through the second region of the enthalpy wheel 80, the heat and moisture is retained in the porous paper or fiber material of the enthalpy wheel 80 and transferred to the incoming dry air stream passing through the first region of the enthalpy wheel 80 in the oxidant supply line 30, as the porous materials or the gas diverting element of the enthalpy wheel 80 rotate around its axis. Then the cathode exhaust stream continues to flow along the recirculation line 40 to an exhaust oxidant water separator 100 in which the excess water, again in liquid form, that has not been transferred to the incoming hydrogen and air streams is separated from the exhaust stream. Then the exhaust stream is discharged to the environment along a discharge line 50.

A drain line 42 may optionally be provided in the recirculation line 40 adjacent the cathode outlet of the fuel cell to drain out any liquid water remaining or condensed out. The drain line 42 may be suitably sized so that gas bubbles in the drain line actually retain the water in the drain line and automatically drain water on a substantially regular basis, thereby avoiding the need of a drain valve that is commonly used in the field to drain water out of gas stream. Such a drain line can be used anywhere in the system where liquid water needs to be drained out from gas streams. Pressure typically increases with gas flow rate and water regularly produced or condensed, and a small flow rate of gas is not detrimental such as cathode exhaust water knockout separator and drain line 42.

The humidified hydrogen from the hydrogen humidifier 90 flows along the fuel supply line 20 to the anode water separator 95 in which excess water is separated before the hydrogen enters the fuel cell 12. Likewise, the humidified air from the enthalpy wheel 80 flows along the oxidant supply line 30 to the cathode water separator in which excess liquid water is separated before the air enters the fuel cell 12.

Fuel cell anode exhaust comprising excess hydrogen and water is recirculated by a pump 64 along an anode recirculation line 60 connected to the anode outlet of the fuel cell 12. The anode recirculation line 60 connects to the fuel supply line 20 at a joint 62 upstream from the anode water separator 95. The recirculation of the excess hydrogen together with water vapor not only permits utilization of hydrogen to the greatest possible extent and prevents liquid water from blocking hydrogen reactant delivery to the reactant sites, but also achieves self-humidification of the fuel stream since the water vapor from the recirculated hydrogen humidifies the incoming hydrogen from the hydrogen humidifier 90. This is highly desirable since this arrangement offers more flexibility in the choice of hydrogen humidifier 90 as the humidifier 90 does not then need to be a highly efficient one in the present system. By appropriately selecting the hydrogen recirculation flow rate, the required efficiency of the hydrogen humidifier 90 can be minimized. For example, supposing the fuel cell 12 needs 1 unit of hydrogen, hydrogen can be supplied from the hydrogen source in the amount of 3 units with 2 units of excess hydrogen recirculated together with water vapor. The speed of pump 64 may be varied to adjust the portion of recirculated hydrogen in the mixture of hydrogen downstream from joint 62. The selection of stoichiometry and pump 64 speed may eventually lead to the omission of the hydrogen humidifier 90.

In practice, since air is used as oxidant, it has been found that nitrogen crossover from the cathode side of the fuel cell to the anode side can occur, e.g. through the membrane of a PEM fuel cell. Therefore, the anode exhaust actually may contain some nitrogen and possibly other impurities. Recirculation of anode exhaust may result in the build-up of nitrogen and poison the full cell. Preferably, a hydrogen purge line 70 branches out from the fuel recirculation line 60 from a joint or connection 74 adjacent the fuel cell cathode outlet. A purge control device 72 is disposed in the hydrogen purge line 70 to purge a portion of the anode exhaust out of the recirculation line 60. The frequency and flow rate of the purge operation is dependent on the power at which the fuel cell 12 is running. When the fuel cell 12 is running at high power, it is desirable to purge a higher portion of anode exhaust. The purge control device 72 may be a solenoid valve or other suitable device.

The hydrogen purge line 70 runs from the position 74 to a joint or connection 92 at which it joins the cathode exhaust recirculation line 40. Then the mixture of purged hydrogen and the cathode exhaust from the enthalpy wheel 80 passes through the exhaust water separator 100. Water is condensed in the water separator 100 and the remaining gas mixture is discharged to the environment along the discharge line 50. Alternatively, either the cathode exhaust recirculation line 40 or the purge line 70 can be connected directly into the water separator 100.

Preferably, water separated by the anode water separator 95, the cathode water separator 85, and the exhaust water separator 100 is not discharged, but rather the water is recovered, from these separators respectively, along a line 96, a line 84 and a line 94 to a product water tank (not shown).

As is known to those skilled in the art, a coolant loop 14 runs through the fuel cell 12. A pump 13 is disposed in the cooling loop 14 for circulating the coolant. The coolant may be any coolant commonly used in the field, such as any non-conductive water, glycol, etc. An expansion tank 11 can be provided in known manner. A heat exchanger 15 is provided in the cooling loop 14 for cooling the coolant flowing through the fuel cell 12 to maintain the coolant within an appropriate temperature range. FIG. 1 shows one variant, in which a secondary loop 16 includes a pump 17, to circulate a secondary coolant. A heat exchanger 18, e.g. a radiator, is provided to maintain the temperature of the coolant in the secondary loop and again, where required, an expansion tank 19 is provided. The coolant in the cooling loop 16 may be any type of coolant as the coolants in cooling loop 14 and 16 do not mix. However, it is to be understood that the second cooling loop is not essential.

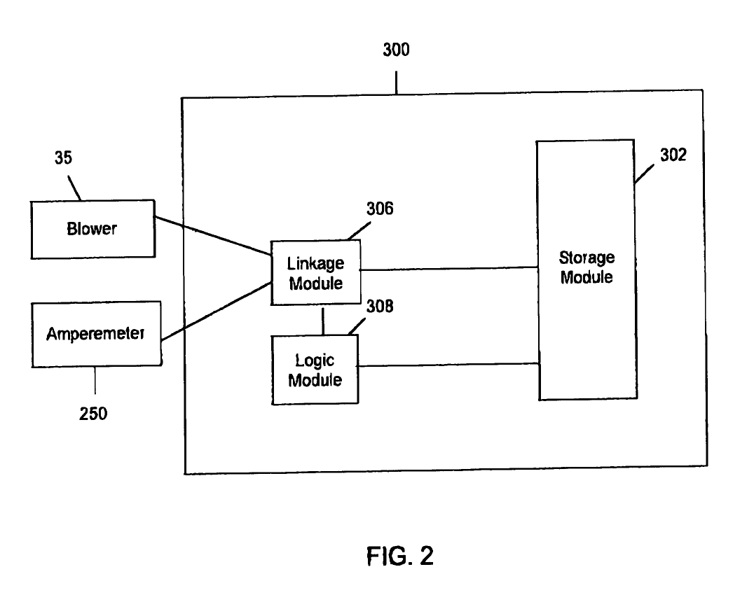

In the invention, as exemplified for the cathode air delivery, a time delay is introduced when a demand for spooling down blower 35 is generated during operation of the fuel cell system. When demand from a load 200 connected to the fuel cell 12 drops off, i.e. the current draw requirements, measured by amperemeter 250 (FIG. 2) go down, the flow of air is held high for a certain pre-set time (for example 10 seconds) at the earlier higher load conditions. This is done so that the fuel cell system 10 can quickly be responsive to any immediate load increase demand shortly after the load demand has decreased. A situation like this might arise when the fuel cell system is powering a moving vehicle and the driver has ceased accelerating, but immediately after slowing down again presses an accelerator pedal, or uses some other means, to increase speed again.

A controller 300 of the system 10 of FIG. 1 is shown in FIG. 2, and compares the previous load level with the current load level, and holds the system air throughput at this level (corresponding to the previous load and operating level of the fuel cell system). The load changes that fall into this category of “abrupt” load changes are changes that occur at at least a pre-determined rate: thus “substantial” changes over “short” periods of time. The actual definition of change rate, “substantial” and “short” will depend on the application the fuel cell system is used in.

By using a system according to the invention near instantaneous transient power output back to a previous load level is possible. In practical use, one transient in power demand (load current draw) may often be followed by another transient in power demand in the opposite direction. Transient power demand is typical for city driving conditions for a vehicle as mentioned earlier, for instance in stop-and-go traffic. In such a situation, a transient reduction in a power demand, resulting from a vehicle stopping or slowing down at a stoplight or due to traffic, may be followed very shortly by a transient increase in power as the way ahead clears for the vehicle and the driver applies more pressure to the accelerator. If the blower is operating at a low rate due to the prior reduction in load, the fuel cell system will be less able to quickly increase power output to meet increased demand. Thus, the controller controls the operation of the fuel cell system in a way that anticipates flow demands that may arise from probable fuel cell system user behavior.

Referring to FIG. 2, the controller 300 is illustrated in a block diagram. The controller 300 includes a storage module 302 for storing a selected time lag and a selected rate of decrease in the load. Both the selected time lag and the selected rate of decrease in the load are selected based on the particular application of the fuel cell system, and may be subsequently modified to improve performance. A linkage module 306 of controller 300 is linked to amperemeter 250, thereby enabling the controller 300 to monitor the load 200 placed on the fuel cell system 10. As demand from the load 200 diminishes, the rate of decrease in the demand is communicated from the amperemeter 250 to the linkage module 306, and from the linkage module 306 to a processor or logic module 308. The processor or logic module 308 then determines whether the actual rate of decrease in the load 200 exceeds the threshold rate of decrease stored in the storage module 302. If the rate of decrease in the load 200 does not exceed the threshold rate of decrease stored in the storage module 302 then the logic module 308 via linkage 306 will reduce the operating level of the blower 35 to correspond to the lower operating level of the fuel cell system 10 needed for load 200. If, however, the rate of decrease in the load 200 exceeds the threshold rate of decrease stored in the storage module 302, then the logic module 308 will delay reducing the operating level of the blower 35 by a period of time equal to the time lag stored in the storage module 302. After this time lag, the logic module 308 will lower the operating level of the blower 35 to correspond to the lower operating level of the fuel cell system 10 needed for load 200.

Other variations and modifications of the invention are possible. For example, instead of, or in addition to, the operating rate of the blower 35 being regulated, the operating rate of the hydrogen recirculation pump 64, and/or the operating rate of the coolant pump 13 as well as other components may be regulated. All such modifications are variations are believed to be within the sphere and scope of the invention as defined by the claims appended hereto.

1. A method of operating a fuel cell system, the method comprising:
(a) operating a component of the fuel cell system at a component operating rate;
(b) driving a load using the fuel cell;
(c) measuring an operating rate of the fuel cell;
(d) normally adjusting the component operating rate in dependence upon the operating rate of the fuel cell; and,
(e) in response to selected changes in the operating rate of the fuel cell, indicative of corresponding changes in the demand from the load, delaying adjustment of the component operating rate.

2. The method as defined in claim 1 further comprising
selecting a threshold rate of change in the operating rate of the fuel cell;
determining whether the rate of change in the operating rate of the fuel cell exceeds the threshold rate of change; and,
when the rate of change in the operating rate of the fuel cell exceeds the threshold rate of change, delaying adjusting the component operating rate.

3. The method as defined in claim 2, further comprising setting a threshold rate decrease in the operating rate of the fuel cell and determining whether the rate of decrease in the operating rate of the fuel cell exceeds the threshold rate of decrease.

4. The method as claimed in claim 3 including setting the threshold rate of decrease as one of an absolute magnitude change in the operating rate of the fuel cell and a proportion of the operating rate of the fuel cell, in a set selected time period.

5. The method as defined in claim 2 further comprising selecting a time lag to delay adjusting the component operating rate.

6. The method as defined in claim 2 wherein the threshold rate of change in the operating rate of the fuel cell is selected based on an operating context of the fuel cell system.

7. The method as claimed in claim 2, wherein the operating rate of the fuel cell is determined by measuring the demand from the load.

8. The method as defined in claim 1 wherein the component is a process fluid delivery device for supplying a process fluid to a fluid cell, and the component operation rate is a process fluid supply rate.

9. A fuel cell system comprising
(a) a fuel cell for driving a load;
(b) at least one measuring device for monitoring an operating rate of the fuel cell;
(c) a controller for controlling an operation rate of a component of the fuel cell system based on the operating rate of the fuel cell; and,
(d) means for detecting selected changes in the operating rate of the fuel cell, indicative of corresponding changes in the demand from the load, and in response thereto, delaying adjustment of the operation rate of the component.

10. The fuel cell system as defined in claim 8 wherein the controller comprises
a memory for storing a threshold rate of change in the load and a selected time lag; and,
a processor for determining whether the rate of change in the operating rate of the fuel cell exceeds the threshold rate of change in the load,
wherein, when the rate of change in the load exceeds the threshold rate of change in the load, the controller delays adjusting the operation rate of the component during the time lag.

11. The fuel cell system as defined in claim 10, wherein the memory stores a threshold rate of decrease, and the processor determines if a decrease in the operating rate of the fuel cell exceeds the threshold rate of decrease.

12. The fuel cell system as defined in claim 11, wherein the memory stores the threshold rate of decrease as one of an absolute magnitude change in the operating rate of the fuel cell and a proportion of the operating rate of the fuel cell, in a set selected time period.

13. The fuel cell system as defined in claim 9 wherein the component is a process fluid delivery device.
